(19) United States
(12) Patent Application Publication
(10) Pub. No.: US 2025/0005638 A1
(43) Pub. Date: Jan. 2, 2025

(54) AGGREGATING ASSET VALUE AND MARSHALLING COOPERATION TO ACHIEVE ECONOMIC BENEFITS AND SOCIAL GOOD

(71) Applicant: Thomas Hecht, Wilbraham, MA (US)

(72) Inventor: Thomas Hecht, Wilbraham, MA (US)

(21) Appl. No.: 18/384,658

(22) Filed: Oct. 27, 2023

Related U.S. Application Data
(63) Continuation-in-part of application No. 18/216,329, filed on Jun. 29, 2023.

(51) Int. Cl. G06Q 30/0601

(52) U.S. Cl. CPC G06Q 30/0613

(57) ABSTRACT

A system for equitable and socially beneficial economic activity is provided that receives a message describing an impending acquisition of products by at least one buyer. The system determines availability of the products as offered by competing vendors and determines at least one vendor among the competing vendors that is owned by a non-profit institution. The system determines a first vendor among the at least one vendor to participate in the transaction and determines that the first vendor is owned by a first non-profit institution. The system oversees consummation of at least one purchase transaction for the products between the at least one buyer and the first vendor. The system determines that distributions by the first institution align with stated values of the at least one buyer. The system determines that distributions by the first institution align with stated values of previous shareholders of the first vendor.

### CROSS REFERENCE TO RELATED APPLICATIONS

The present non-provisional patent application is a Continuation-In-Part of U.S. Non-provisional patent application Ser. No. 18/216,329 filed Jun. 29, 2023, entitled Asset Allocation for Optimization of Collective Economic Benefit.

### FIELD OF THE DISCLOSURE

The present disclosure is in the field of asset management. More particularly, the present disclosure teaches systems and methods of influencing and controlling transactions to more efficiently use assets directed toward greater social good, actions which include creating specialized asset ownership entities optimally structured to own assets, maximize economic benefits of ownership, and share at least some of the maximized benefits with users as at least incentive to the users to participate.

### BACKGROUND

In a capitalist free market economy and democratic society, ownership of assets is traditionally viewed as a sign of economic strength, power, and prestige. Private property rights are a core pillar of the American ethos. A central tenet of the Founders' philosophy was and remains control of one's own destiny and wellbeing which equated to owning property, particularly tangible property, both real and personal. Expansion of owned property and continued acquisition of property supports prestige in the American mind.

The industrial revolution, which was based on manufacturing and mechanized harvesting of resources, meant machines and hard, productive assets. While capital, the lower right side of the balance sheet is what truly matters, assets on the left side of the balance sheet, even if leveraged with heavy debt, are what Americans take pride in.

Legal ownership of assets provides psychological and economic benefits. Usage of assets provides a separate set of benefits which in most Americans' minds are closely tied to ownership benefits. But ownership and usage are in fact separate economic concepts that need not be coupled. Americans are gradually realizing that ownership and usage are not the same thing and can, in fact, be decoupled. An owned asset that performs no useful function, such as a working motor vehicle that rarely leaves its garage, is less valuable than another vehicle that is not owned but is instead leased but provides daily transportation for the user.

While a great piece of art of course has significant intrinsic value, Americans in an affluent and mobile society increasingly value experiences. The value of experiences and benefits derived therefrom can be compromised or lessened by the burden of owning assets needed to make such experiences happen. A boat owner may come to realize that vacationing on a cruise ship is less burdensome. An owner of a large recreational vehicle may eventually find that his/her resources and time are better spent on a professionally guided tour.

Ownership of large assets has never been as exciting or rewarding as it appeared. Americans will eventually see the benefits of use by itself as opposed to use combined with ownership.

Institutions and individuals are incentivized by short-term gains, quarterly reporting, and political term considerations. The race for short-term gains has created a system characterized by unsustainability and overconsumption in a finite world. Systems and methods provided herein as described below seek to perpetuate sustainability and conscious capitalism.

Recent trends including the rise of Uber and Airbnb wherein transportation and short-term lodging, respectively, are disintermediated from ownership exemplify the gradual change in consumer consciousness that partially forms the basis for the present disclosure. As American and advanced western societies evolve away from manufacturing and industrial economies, the ownership of hard assets will receive less emphasis.

Economic activity which consists primarily of transactions is a narrow and limited endeavor and does not consider social good or benefit to society as a whole. Focused on financial gain, most transactions deal with exchange of objects of tangible and measurable value. The exchanged objects are merely the immediate factors or elements of a transaction, for example goods for cash. Other factors of transactions are present as well, which may be non-financial and therefore difficult to see, to account for, and to accurately attribute costs and benefits thereof.

Most economic activity has social, environmental, and other consequences beyond the immediate terms and exchange of value. Those consequences may not be readily visible or quantifiable. The exclusion of environmental consequences, for example, from transactions, may lead to environmental damage. Such damage has a definite cost that is incurred and can't be avoided. The cost will have to be paid by some party at a future date.

Similarly with social impact, much economic activity carries with it social costs that impact upon people and communities. Such costs are real although difficult to immediately recognize and account for. As with environmental costs, those social costs are incurred and must be paid in some manner, usually in the form of poverty and social disadvantage for those afflicted and their descendants.

Incomplete costing of factors, including indirect factors described above, to transactions has long term consequences, in many cases adverse to society as a whole. Disregarding social good in economic activity by most parties engaged in commerce is usually injurious and carries long term costs to society.

Assets in free market economies are frequently underutilized and may be effectively abandoned by their owners in favor of newer and more productive assets. Transactions often do not properly value assets exchanged. Value often flows to parties that do not deserve, need, or even want the value or have no way of realizing the value. Value is hence disclaimed or otherwise lost. But many assets retain market value and utility long after they have been fully depreciated and are no longer on their owners' books. Conventional accounting practices and tax laws often do not recognize residual value and properly capitalize that value. Few incentives exist for managers to wean or extract residual value from aged assets.

Competitive free markets do not necessarily extract optimal or even fair value from assets. Legal ownership of assets may also not be optimal for users of such assets. In many instances, possession and use of assets is preferable to ownership of assets.

Free markets on a larger scale do not always align parties in transactions in an efficient manner. Zero sum competition creates winners and losers with the above social costs incurred and left to be paid by society over subsequent years and decades.

### BRIEF DESCRIPTION OF THE FIGURE

FIG. 1 is a block diagram of a system of asset allocation for optimization of collective economic benefit according to an embodiment of the present disclosure.

### DETAILED DESCRIPTION

Systems and methods provided herein separate asset ownership from asset use. Use of an asset need not equate to ownership of the asset. While renting and leasing are long established concepts, the present disclosure teaches creation of a specialized entity structured for maximum economic benefit to own assets, lease assets to users, and pass benefits associated with their superior structure back to the user.

The present disclosure teaches that ownership may be reallocated from a user who owns an asset but is not deriving maximum advantage or benefit therefrom to such a specially structured ownership entity. The user, who is the original or previous owner of the asset, continues to enjoy usage of the asset on a long-term basis and derives benefits from participation in the system provided herein.

The new owner, by virtue of its specialized structure including legal, accounting, and tax status, receives economic benefits that exceed the benefits that the user would have received had the user continued to own the asset. In exchange for the user relinquishing or waiving ownership and agreeing to the arrangement described herein, the user receives a portion of the superior economic return realized by the ownership entity. Maximum economic benefit is realized and shared and both parties benefit whereas economic benefit would have been foregone and forfeited had the user not entered into the arrangement described. The collective benefit realized exceeds what the user would have received on its own.

Systems and methods provided herein extend beyond tangible assets such as real property, for example land and buildings, or personal property such as large, long-lived assets, for example vehicles or machines. Intangible but important financial assets such as employer matching on employee retirement accounts or employee stock purchase plans (ESPP) are subject to an economic and psychological phenomenon similar to the above as employees often fail to take full advantage of benefits available to them. Systems and methods provide similar ownership or management vehicles to temporarily control such assets on behalf of employees such that maximum value can be earned until the employee is ready to receive the account or other asset.

In both cases of tangible assets and financial assets as well as other types of assets, the specialized entity is created and structured to own or control property for maximum collective benefit. Incremental and maximized benefit arising from assets' ownership by the entity is partially returned to the user as at least an incentive to the user to participate.

The present disclosure teaches disintermediating an asset from its user. It is not necessary for a user of an asset to own the asset and in many cases, it makes more economic sense for the user not to own the asset. From an economic standpoint, the user is better off with the asset held by another party because more economic benefit is available to the other than to the user.

Because more benefit is realized by the other party owning the asset than the user and some of the greater benefit can be returned to the user, it makes more sense for the user to have the other party own the asset. Some of this may go against the hard capitalist instincts of many people to legally own and therefore control assets. But insistence on legally owning an asset can have significant opportunity costs when the asset's value is better realized when the asset is owned by another party than the user. Owning the asset allows the user to feel like he has more control, but that desire for control actually imposes significant opportunity costs on the owner that he may not be considering.

The present disclosure is predicated on placing ownership with the party who can derive the most economic benefit from the ownership. The party then shares the economic benefit with the user who realizes greater benefit than if he the user owned the asset. The party that owns the asset can later transfer ownership to other asset owners who may extract even greater benefit and thereby pass a portion of that greater benefit to the user.

Systems and methods are provided for ownership entities to be structure for maximum non-user ownership benefit. From accounting, tax, legal, and regulatory perspectives, such entities may exist solely or primarily to hold assets, benefit maximally from their own structure, and pass benefits back to users in various forms.

Over the useful life of an asset, ownership may transition between different ownership entities based on economic and other factors. Demand for a type of asset inevitably changes over a long term based on the nature of the asset, the changing quantity and characteristics of the user population, and competing asset types, and innovative replacements that may be cheaper, longer lived, and offering greater functionality.

The system therefore contemplates that a given asset during its useful life may be owned by a succession of ownership entities in addition to, of course, having many users. During the asset's life, the system may determine which prospective user who has registered interest in the asset is best suited to take possession of and begin using the asset at a given time during the life of the asset. For an asset or group of assets in a pool, the system monitors demand for the assets and analyzes specific characteristics of prospective users.

The system further tracks long term demand for various asset types with objectives including accumulating or acquiring assets only when needed. An objective herein is to efficiently acquire and use assets which enhances economic returns and benefits for asset ownership entities as well as users.

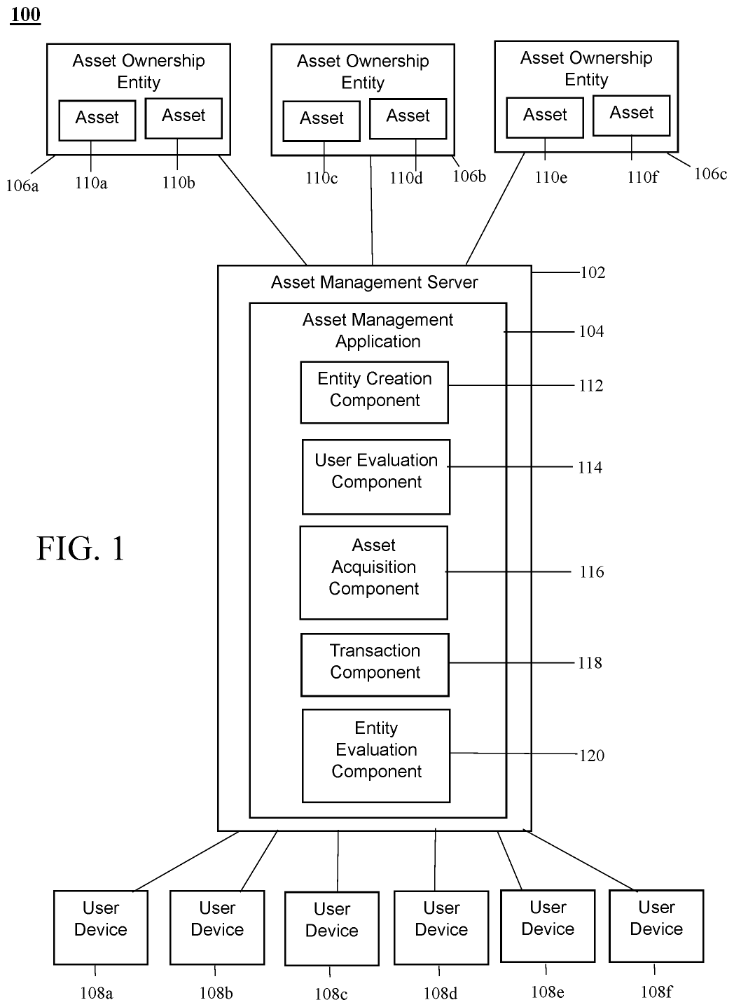

Turning to the figure, FIG. 1 is a block diagram of a system of asset allocation for optimization of collective economic benefit according to an embodiment of the present disclosure. FIG. 1 illustrates components of a system 100 comprising an asset allocation server 102 and an asset allocation application 104, referred to hereafter for brevity as the server 102 and the application 104, respectively.

System 100 also comprises asset ownership entities 106a-c, referred to hereafter for brevity as the entity or entities 106a-c. System 100 also comprises user devices 108a-e in possession of users and assets 110a-f.

System 100 also comprises five components that may be components of the application 104: an entity creation component 112, a user evaluation component 114, an asset acquisition component 116, a transaction component 118, and an entity evaluation component 120.

The server 102 is at least one physical computer that may be situated at more than one geographic location. The application 104 executes at least on the server 102 and may comprise multiple software applications, modules, and components stored and executing on devices associated with the server 102.

Asset ownership entities 106a-c, or entities 106a-c, are specialized legal units formed to own assets 110a-f for the benefit of extracting maximum or nearly maximum economic value and passing much of the value back to users of the assets 110a-f. The entities typically have legal, accounting, and tax structures to maximize collective economic benefits of their owning but not using the assets. Typically, entities 106a-c pass benefits of ownership back to users of the assets 110a-f.

Systems and methods are predicated on an economic fact that many users of assets 110a-f, both consumer and commercial, do not take full advantage of ownership of their assets from accounting, economic, tax, regulatory, and other perspectives. They therefore are foregoing benefits or “leaving money on the table.” Entities 106a-c are provided herein to own such assets, extract maximum collective benefit, and share some or all the extracted benefits with users.

Assets 110a-f may be large assets such as motor vehicles or buildings. Assets 110a-f may preferably be productive assets that a user needs as opposed to a leisure-oriented asset such as a pleasure boat that they might more readily abandon once no longer needed. Of course, credit rating of a user is also a consideration as the user will in most cases be making installment or lease payments to the entity 110a that owns the asset or with the application 104.

The entity creation component 112 of the application 104 creates new entities 106a-c when the need arises. In embodiments, an entity 106a-c can own more than one asset 110a-f and in many cases, it may own multiple assets 110a-f depending on the asset type, the user, and other circumstances.

The user evaluation component 114 examines users, their immediate and future needs, and their financial and credit records. The user evaluation component 114 makes decisions and recommendations about which users should receive assets 110a-f and when they should receive them.

The asset acquisition component 116 secures possession and ownership of assets 110a-f to be placed with entities 106a-c. In some instances, an asset 110a-f will be acquired from the user that previously owned it. In other cases, the asset acquisition component 116 acquires an asset 110a-f from another party. The asset 110a-f may in many cases be new when it is first placed with the entity 106a that will own the asset 110a-f and enter into a transaction with a user as described herein.

The transaction component 118 of the application 104 oversees execution of transactions between entities 106a-c and users. This includes any negotiation, setting of terms, and documentation. The terms include how much of the collective benefits will be returned to the user.

The entity evaluation component 120 reviews new entities 106a-c that are being created and reviews existing entities 106a-c for regular reviews or when problems are reported. The entity evaluation component 120 makes determinations and advises on whether a given new or existing entity 106a is suited to enter into a transaction with the user for the particular asset 110a the user wants.

Businesses have lower taxes and are minimally restricted. Individuals have a progressive tax code and are restricted. Systems and methods therefore move assets to the most favorable set of conditions and mimic ownership within the constraints.

Because a large percentage, perhaps 90%, of US individual tax filers file the standard deduction, they receive no tax benefits for charitable deductions. Systems and methods add means to capture the marginalized capital as contributions through businesses. Similar to how the present disclosure converts individual assets to business assets, the present disclosure promotes business and nonprofit assets to coexist.

The present disclosure also provides for a collective system of pools of assets and groups of users and ownership entities 106a-c working together in matching assets and users that need them the assets. The system could execute method steps of 1) opting in assets, 2) formalizing the ownership of the assets into the most beneficial set of conditions, 3) enabling participants, including users, ownership entities 106a-c, and others, to elect how to put those assets to use, and 4) users receiving value in ownership entities 106a-c and the collective value of assets. Securities may be created that are backed by the pooled system assets, tangible and intangible, that can be used as a currency within the system.

The present disclosure also addresses the aforementioned problem of the high percentage of US taxpayers electing the standard deduction and therefore receiving no tax benefit from charitable contributions. Businesses can donate and deduct those charitable contributions, so the system can solve aspects of that problem by deducting as business deductions or gifting contributions to someone who is eligible.

As an extension, non-profit entities can now own for-profit entities and the mechanism will apply that at a large scale, so that many commodity can be owned by a non-profit. The end goal is similar to the primary embodiment provided herein. The system is matching intended resources with their goals in the most optimized, tax efficient, way.

The present disclosure also provides for a systematic disaggregation and reassembly of companies into more efficient structures with deconsolidating assets to minimize risk, maximize tax sheltering, and maneuvering effectively but of course legally and ethically against regulation. This coincides with the broader idea of evolving laws and constraints. Assets are envisioned as existing in a hybrid state as personal assets and business assets are available for non-profit monetization. Many assets may be assigned/owned by many entities concurrently.

The present disclosure also provides for non-pooling, one-for-one transactions. Anyone who elects the standard deduction (the aforementioned large percentage of taxpayers) cannot deduct charitable contributions. However, if a first person itemizes and a second person does not itemize and they sit next to each other in a church or other charitable function, the second person could legally gift his/her donation to the first person who gets the deduction and saves 35%. Because of a progressive tax system, the 35% for one person may be 25% for another, so there is a level of optimization.

Another element that is that is important throughout this system is trust. Many individual assets can't be legally transferred, such as the charitable deduction (benefits like ESPP/401k and lawsuits), so where the system is able, it creates securities to match an asset cycle.

The present disclosure also redirects traditional charitable deductions into stable value-generating assets run by this system. The system gets compensated as operators. This structure may be compelling because providing a platform for non-profits to generate stable profits is as a better alternative to more traditional fundraising. For example, linking a social cause to a competitively priced commoditized transaction (ex: sports betting to any goods and service) is a sustainable competitive advantage.

The present disclosure also opts in anything with potential value/utility and provides mechanisms to monetize it/broker value and share the net gains from things like tax savings, disintermediation of middlemen, value preservation, utility as simple as a feeling secure (ex: Maslow's hierarchy of needs). All this value can be transferred within a system to best match individual or collective utility.

The present disclosure also can set up future transactions based on predictable changes in utility, like transferring a house or other dwelling from an empty nester to a new family and balance out transactions using the security of the system with future promises. This can be done 1:1, matching parties' individual utilities, or in a pooling fashion, similar to insurance risk pooling and pooling of like future promises.

The system may support an overall arbitrage structure by converting assets to hybrid assets (ex: personal, business, government, non-profit) via transfer and public-private partnerships. Hybrid alternative institutions, for example debt underwriting, insurance, and derivatives, may allow for superior risk to reward profiles. The sharing of information enables for better decision making for an array of circumstances for collaborators. For example, sharing results from a vetting process or due diligence may bring value and opportunity to recycle otherwise wasted effort such as referring quality candidates or deal flow between entities and to further enhance the transfer and portability of assets and liabilities between entities. Institutional disaggregation and reassembly from opt into to more tax and operationally efficient business structures may also be provided for herein.

The system may broker asymmetric and consequential deals using existing and alternative capital in a way that minimizes acquisition costs and maximizes lifetime value of assets. This is an alternative capital investment bank and hybrid asset that facilitates interdependent activities between institutions, business, and individuals.

Regarding non-profit institutional transformation, the system may transform non-profit infrastructures to for-profit, social enterprise systems. This may loosely parallel the presently popular narrative with ESG (environmental, social, and corporate governance) funds containing public equities. The system may operate and collect fees.

The system may convert revenue generating nonprofit organizations to for-profit B-Corporations. Health care clinics, Goodwill, and YMCA-gyms may be included to enhance the ability to serve their mission. This dovetails with proprietary deal flow in an overvalued market.

Systems and methods may also apply to what is commonly referred to as the Newman's Own Philanthropic Exception. Revenue may be earned as business operators for non-profit owned businesses and platforms. A non-profit marketplace may take shape, competitive with any commodity that has the distinct advantage of financing charitable and social enterprising activities. The system may direct marginalized charitable to ESG funds within marketplace systems. The system may also earn buy in from collective influence and resources (tangible/intangible) of non-profit boards and opt in contributions to the vision.

Public/Private partnerships may be supported via social enterprise narratives to overcome regulatory hurdles and bipartisanship. Hybrid funds may be mapped to UN 17 sustainable development goal, driven by the system. Partnerships with civic minded influencers may be supportive comprising retired/political candidates, board members of for/non-profits, and athlete and celebrities who wish to be influencers and support various causes.

Systems and methods also support the disaggregation and reassembly of existing entities/institutions to enhance interdependence between entities and repeat and scale value adds. An example is in the practice of accounting. People prefer symmetry and as a result, most companies have their year-end as December 31, when in reality companies' year end could be any other day of the year. The December 31 dynamic creates a supply and demand mismatch for regulated and/or deadline-driven services including audit and tax, resulting in a needless premium for those services. Similarly, month closes are often the last day of a month when it could be any day.

Recurring functions such as monthly or quarterly closing of books have ebbs and flows of workload. The present disclosure provides for multiple entry points (ex: bottom-up, top-down, middle-out). Functions from entities can be siphoned and optimized in a pooling fashion. In the example, systems and methods can funnel the accounting function to a specialized accounting entity and restate a more optimal year-end that balances with the fulfillment entity. This method can apply to many functions within a company or institution.

Ownership of assets can be held by multiple co-owners concurrently. For example, equipment and employees for a trucking company could be legally domiciled under more than one legal entity to enable interchangeable fulfillment among multiple carriers in a pool.

In an embodiment, a method for allocating asset ownership for maximized collective economic benefit is provided. The method comprises a computer receiving information about a user and an asset used or to be used by the user. The method also comprises the computer identifying areas based at least on the received information in which the user's actual or planned use of the asset does not take maximum economic benefit associated with ownership of the asset. The method also comprises the computer searching a database describing a plurality of asset management entities with legal and structural characteristics suited to achieving maximum economic benefits associated with ownership of the asset. The method also comprises the computer selecting a first asset management entity of the plurality of entities to match with the user. The method also comprises the computer executing a transaction providing ownership of the asset to the first asset management entity and providing usage of the asset to the user, the transaction returning a portion of the economic benefits realized by the entity in the transaction to the user.

The method also comprises the computer evaluating the user's financial and tax status described in the received information in identifying areas in which the user's actual or planned use of the asset does not take maximum economic benefit associated with ownership of the asset. The method also comprises the computer selecting the first asset management entity based at least in part on the entity's ability to extract economic benefit from its ownership of the asset.

The method also comprises the computer selecting the first asset management entity based on at least one of legal, structural, tax, and financial strengths of the entity compensating for at least one of legal, structural, tax, and financial weaknesses exhibited by the user. The method also comprises the computer overseeing a program that matches users of assets with asset management entities to promote optimal realization of economic benefits from use of the asset by the user and ownership of the asset by an asset management entity selected by the computer to own the asset.

Over a useful life of an asset in the program, the asset may have multiple owners and may have multiple users. The method also comprises the computer invoking a change of ownership of the asset based on an observed decline in economic benefits of the transaction, due in part to changes in at least legal, structural, tax, and financial strengths of the asset management entity presently owning the asset. The method also comprises the computer endeavoring to maximize economic benefit of the transaction to maximize return of the portion of benefits to the user as compensation to the user for participating in the program.

In another embodiment, a method for deriving benefit from funds forfeited by employees under employer-sponsored programs is provided. The method comprises a computer receiving funds from an employer, the funds representing employer contribution amounts forfeited by employees during selection of employer-sponsored compensation programs. The method also comprises the computer investing the received funds with risk, return, and maturity characteristics aligning with projected needs of the employees. The method also comprises the computer sharing returns on the invested funds with employer and employees during duration of employee ownership of assets associated with the programs. The method also comprises the computer paying a first portion of the invested funds and returns on the invested funds to employees upon liquidation of the assets and paying a second portion of the invested funds and returns on the invested funds to the employer upon the liquidation.

The employer-sponsored compensation program is a 401 (k) plan, and the employer contribution is an employer matching amount permitted under 401 (k) guidelines. The employer-sponsored investment program is an employee stock purchase plan (ESPP), and the employer contribution is an employer subsidy permitted under guidelines of the ESPP. The method also comprises the computer paying the first portion to incentivize employees to more actively participate in the programs. The method also comprises the computer paying the first portion to support the employer building employee loyalty and longevity in tenure.

In yet another embodiment, a system for efficiently using assets is provided. The system comprises a computer and application executing thereon that receives a message that a first asset has been added to a pool of assets made available to a customer base for use. The system also determines that a subset of the customer base indicated interest in using the first asset, wherein a first group of customers in the subset do not immediately need the first asset. The system also arranges the subset by chronological time periods of interest expressed by customers in the subset. The system also selects, based on the interested chronological time period of subset customers and on legal and business characteristics of subset customers, a first set of subset customers to receive use of the first asset during specific time periods at least partially matching their chronological time periods of interest, the selection placing the first group for first asset use at a late stage in a useful life of the first asset.

The pool of assets is made available to customers in transactions with asset ownership entities. The system selects asset ownership entities for specific transactions based on the entities' abilities to generate maximum economic benefit from ownership of a subject asset and return a portion of realized benefits to users of the assets in the transactions. The system arranges ownership transactions for the first asset for future execution based on an expected future set of conditions for a user.

The system chronologically allocates usage of the first asset to users in the subset based at least on the users' expressed chronological needs for the first asset and further based on users' fitness to use the first asset, the fitness determined by the system. The system structures transactions with built-in flexibility to accommodate changes in applicable laws. The system assigns assets to combinations of interested users and asset ownership entities considered most optimal based on evaluations by the system.

Embodiments provided above describe how specialized ownership entities 106a-c may be created to own assets 110a-f and pass benefits arising from their advantageous legal and economic status to other entities that use the assets 110a-f. Such other entities may in some cases may be previous owners of the assets 110a-f and were not able for various reasons to take full advantage of ownership of the assets 110a-f. Hence, embodiments described above provided for those other entities to transfer ownership of the assets 110a-f to ownership entities 106a-c and receive benefits passed back to them from the ownership entities 106a-c, the benefits arising from the optimal or near-optimal legal and economic status of those specialized ownership entities 106a-c.

Components of the system 100 and illustrated in FIG. 1 may be applicable in systems and methods described henceforth that expand on the previously provided embodiments and further oversee and exert influence on a plurality of private and public entities. Systems and methods go beyond asset ownership and usage and align parties in transactions and relationships. Such alignment endeavors to make more efficient use of legal and economic status and resources of parties in using assets efficiently and well.

Advancing social good is a key objective of the further embodiments provided henceforth. Systems and methods provided in the embodiments below are directed to broader and higher objectives of deploying assets and other resources in manners that advance the collective social good. Systems and methods have access to information regarding the economic and legal status and resources of such entities and their activities. Systems provided herein may exert influence and even control over transactions and relationships based at least on the information they have about various entities and their activities.

Systems and methods are directed to broadening and expanding elements of transactions from conventional exchange of goods and funds to further encompass collective benefit for all stakeholders to economic activity, including stakeholders beyond immediate transacting parties. Instead of simple monetary, economic, or material gains or losses realized by the parties, systems provided herein account for all costs and benefits of transactions. These may include not easily visible or measurable costs and benefits. These include transaction aspects that do not have overtly tangible favorable and adverse impacts and may involve parties not immediately participating in transactions, but still nonetheless affected. Economic activity is evaluated by systems provided herein for its collective cost and benefit to all stakeholders including those non-immediate parties and society as a whole.

Systems and methods may transfer assets and/or liabilities to the optimal party in a pooling fashion. This transfer of ownership may unlock value and remove barriers to collaboration. Labor and assets, including scale and best practices, provides elements of Porter's Value Chain. The present disclosure aggregates new value and potential gains in an organized fashion as characterized by Porter's Value Chain. All value producers can be compensated as they normally would for performing a function. But the system scales their processes or fills in excess capacity.

The present disclosure is predicated on the philosophy that there is a distinct value of cooperation among parties to transactions as opposed to zero-sum competition which is often adversarial. Gains may be realized from initial value arbitrage, efficiency gains and scale. Recent startup companies such as Uber and Airbnb offer aggressive discounts to consumers or bonuses to capture initial market share. This action contrasts with traditional capital-intensive strategy where all benefits go to investors. Systems and methods provided herein teach that benefits can be achieved through shared sacrifice and allocation of benefits that incentivize long-term collaboration and sustainability as opposed to short-term cash returns.

Social good resulting from economic activity, i.e., aggregate economic and social utility, as an alternative to tangible profit maximization, is a principal objective of the present disclosure. Instead of focusing on merely assets and liabilities, an interdependent layer provided herein brings in additional stakeholders to highlight and assert their interests and well as charge them appropriately with their responsibilities associated with fiduciary duties, such as accountants. Value generation in transactions is more than measurable monetary outcomes and includes less measurable and tangible but real factors. All stakeholder interests are served, and fiduciaries of each participating entity are held responsible and compliant. Value generation is for the entity combination. Allocation of production of goods in a transaction is system-based as are allocation of benefits. Such allocations are based on the system as a whole wherein all stakeholders are fairly served and compliance by fiduciaries is ensured.

The system better allocates value creation and benefits. The system considers specific operational limitations and interests of each party. Varied entities, each with their own unique objectives, incentives, rules and restrictions, may be involved in transactions. Non-profit organizations have tax advantages and government-citizen relationships have inherent constraints. Systems and methods provided herein may reduce or eliminate barriers and foster collaboration.

Social good and societal interests are objectives herein. In driving toward those goals, the system seeks to open participation to traditionally excluded assets/entities in commercial transactions. For example, often because of rules and duties associated with non-profit organizations' missions and governments' duties to citizens, assets of these non-commercial entities may often by underutilized.

Along the lines of the hybrid salaried/contractor worker and the hybrid personal-business asset class discussed elsewhere, systems described herein provide a universal-hybrid entity type that enables collaboration by any potential value generators. Such an entity works to understand its duties and obligations and allocate production and benefit within those constraints where they exist. This is an overlay on established Western economic systems that may be inherently more just. Compatible and to that end, systems and methods could extend to a hybrid currency in the form of marketable security that is backed by these efficiency gains and designed for maximized aggregate utility. It is designed for such utility because it is representative of most or all interests (ex: a weighted average currency). The system may further address issues associated with digital currencies.

The system may better allocate value creation and benefits, considering the specific operational limitations and interests of each party. For example, using what is informally known as Newman's Own exception, the approach provided herein eliminates barriers, fosters collaboration, and builds upon current patent applications. Systems and methods segment production and value into adaptable units or pools that have customized restrictions, ensuring each participant is adequately recognized and benefits in line with their stakeholder interests and regulatory boundaries.

Newman's Own exception, codified as Section 4943 (g) of the Internal Revenue Code, allows a private non-profit foundation to own a for-profit entity. To qualify, 100% of the profits of the for-profit corporation must be donated to charity. The corporation also must be independently controlled and managed apart the non-profit corporation. The previous prohibition of for-profit entities being owned by non-profit entities is no longer in place as a result of the enactment of the Philanthropic Enterprise Act of 2017 as part of the Bipartisan Budget Act of 2018, under which an exception to the excess business holdings rule was created to allow a private foundation to own 100 percent of an operating business provided, however, certain rather stringent requirements are met under new tax code Section 4943 (g).

Contrary to rules in effect since the 1969 Act, if the requirements under the new exception are met, owners of companies that want to devote all profits from their businesses to charity may now place their companies under the sole ownership of a private foundation and permanently devote all of their profits for charitable purposes. This new exception creates what is, in essence, a “philanthropic business enterprise” that is exempt from the excess business holdings rule.

The present disclosure teaches that for-profit companies may domicile themselves under private foundations such that their profits may be directed to charitable causes that benefit the social good. A for-profit company may operate as it would under normal circumstances but channel its profits to the non-profit parent entity. Parties that control the non-profit parent can direct their distributions to causes that are approved by the previous owners of the for-profit company. In this manner, a profitable company that may be a candidate for change in ownership because, for example, a family controlling the company wishes to divest itself of the company but remain in control of how the profits from the company are used. Significant social good may result from this structure.

Three embodiments are illustrated below as examples of how the Newman's Own exception may be applied follow below. The first example involves a purchase of products by a buyer and choosing a vendor of the products that is owned by a non-profit organization. The system determines that distributions by the non-profit organization align with stated values of the buyer. The system also determines that distributions by the non-profit organization align with stated values of previous shareholders of the first vendor, persons who owned the first vendor and sold the first vendor to the non-profit organization. The system is assuring that the transaction aligns with values of both the buyer and the non-profit organization which owns the vendor.

The second example involves creation of a non-profit organization to take ownership of an existing for-profit company owned by parties possibly interested in divesting themselves of the for-profit company. The non-profit organization is created with distribution philosophy that aligns with the values of the parties presently owning the for-profit company. The parties can know that after they sell the for-profit company to the non-profit organization that distributions of the non-profit organization will align with their own values.

The third example involves an existing for-profit company with rights to a stream of profits being sold to a non-profit organization that will distribute the profits to causes that align with values of the owners of the for-profit company. The system effectively matches the for-profit company with the non-profit organization based on non-financial goals of the shareholders of the for-profit company.

In each of the three examples summarized above, for-profit companies become subsidiaries of non-profit organizations based on alignment of values of the parent and subsidiary management and ownership. Profits of the for-profit subsidiaries are channeled into and through the parent non-profit organizations and distributed to causes favored by the management and ownership groups. All of the legal structures of these parent/subsidiary arrangements would of course need to be fully in compliance with Section 4943 (g) of the Internal Revenue Code and any other applicable regulations.

The objectives of these examples of legal structuring to make good use of the Newman's Own exception is to show how activities directed to profit generation can be redirected to charitable causes that benefit society as a whole. As noted, a central objective of systems and methods provided herein is to direct profit-oriented activity to causes that produce social good. Cooperation as opposed to hard competition is an underlying theme accompanying an inventor philosophy that social good can be the result of cooperation between transaction parties.

A more detailed description of the three examples summarized above follows. In an embodiment, a system for equitable and socially beneficial economic activity is provided. The system comprises a processor, a memory, and an application stored in the memory that, when executed by the processor, receives a message describing an impending acquisition of products by at least one buyer.

The system also determines availability of the products as offered by competing vendors and determines at least one vendor among the competing vendors that is owned by a non-profit institution. The system also determines a first vendor among the at least one vendor to participate in the transaction and determines that the first vendor is owned by a first non-profit institution. The system also oversees consummation of at least one purchase transaction for the products between the at least one buyer and the first vendor.

The system determines that distributions by the first institution align with stated values of the at least one buyer. The system determines that distributions by the first institution align with stated values of previous shareholders of the first vendor.

The stated values of previous shareholders of the first vendor are those values expressed by the previous shareholders at the time the non-profit institution acquired ownership of the first vendor. The at least one buyer appoints the system to identify the first vendor.

The at least one buyer provides a directive to the system to oversee consummation of at least one purchase transaction. The system aligns buyers with vendors owned by nonprofit institutions to benefit non-commercial and charitable causes.

In another embodiment, a method of combining for-profit entities with non-profit institutions directed to achieving social good is provided. The method comprises a computer creating a non-profit institution with a stated mission directed toward a social good. The method also comprises the computer identifying an existing for-profit entity with shareholders seeking to divest ownership. The method also comprises the computer determining that the shareholders share the stated mission. The method also comprises the computer directing acquisition of the entity by the institution.

The non-profit institution is a charitable organization that distributes to causes aligning with the shared stated mission. The computer periodically audits distributions of the non-profit institution. The method also comprises the computer directing that the acquisition of the entity by the institution is consummated on a non-cash basis.

The method also comprises the computer directing that the shareholders have no legal role in management of the institution. The method also comprises the computer verifying that the for-profit entity is an established legal entity, is a going concern, and is commercially oriented.

In yet another embodiment, a method of redirecting commercially generated profits to non-profit charitable causes is provided. The method comprises a computer identifying a for-profit entity with contractual right to profits generated by a portfolio of transactions. The method also comprises the computer analyzing ownership structure of the entity to determine propensity to divest to a non-profit institution. The method also comprises the computer analyzing, based at least on the determined propensity, non-financial goals of stakeholders of the entity. The method also comprises the computer directing a change of ownership of the entity from stockholders to a first non-profit institution.

The method also comprises the computer verifying that the portfolio is held and managed by a second entity separate from the for-profit entity. Profits from the portfolio are a sole source of revenue for the for-profit entity.

Non-financial goals of the stakeholders are charitable and align with goals of the first non-profit institution. The method also comprises the computer advising the first non-profit and the for-profit entity to consummate the change of ownership on a non-cash basis. The method also comprises the computer auditing distributions of the first non-profit institution to verify continued alignment with non-financial goals of the stakeholders.

1. A system for equitable and socially beneficial economic activity, comprising:
a processor and a memory; and
an application stored in the memory that when executed by the processor:
receives a message describing an impending acquisition of products by at least one buyer,
determines availability of the products as offered by competing vendors,
determines at least one vendor among the competing vendors that is owned by a non-profit institution,
determines a first vendor of the at least one vendor to participate in the transaction,
determines that the first vendor is owned by a first non-profit institution, and
oversees consummation of at least one purchase transaction for the products between the at least one buyer and the first vendor.

2. The system of claim 1, wherein the system determines that distributions by the first institution align with stated values of the at least one buyer.

3. The system of claim 1, wherein the system determines that distributions by the first institution align with stated values of previous shareholders of the first vendor.

4. The system of claim 3, wherein the stated values of previous shareholders of the first vendor are those values expressed by the previous shareholders at the time the non-profit institution acquired ownership of the first vendor.

5. The system of claim 1, wherein the at least one buyer appoints the system to identify the first vendor.

6. The system of claim 1, wherein the at least one buyer provides a directive to the system to oversee consummation of at least one purchase transaction.

7. The system of claim 1, wherein the system aligns buyers with vendors owned by nonprofit institutions to benefit non-commercial and charitable causes.

8. A method of combining non-profit institutions with for-profit entities directed to achieving social good, comprising:
a computer creating a non-profit institution with a stated mission directed toward a social good;
the computer identifying an existing for-profit entity with shareholders seeking to divest ownership;
the computer determining that the shareholders share the stated mission; and
the computer directing acquisition of the entity by the institution.

9. The method of claim 8, wherein the non-profit institution is a charitable organization.

10. The method of claim 8, where the non-profit institution distributes to causes aligning with the shared stated mission.

11. The method of claim 8, wherein the computer periodically audits distributions of the non-profit institution.

12. The method of claim 8, further comprising the computer directing that the acquisition of the entity by the institution is consummated on a non-cash basis.

13. The method of claim 8, further comprising the computer directing that the shareholders have no legal role in management of the institution.

14. The method of claim 8, further comprising the computer verifying that the for-profit entity is an established legal entity, is a going concern, and is commercially oriented.

15. A method of redirecting commercially generated profits to non-profit charitable causes, comprising:
a computer identifying a for-profit entity with contractual right to profits generated by a portfolio of transactions;
the computer analyzing ownership characteristics of the entity to determine propensity to divest to a non-profit institution;
the computer analyzing, based at least on the determined propensity, non-financial goals of stakeholders of the entity; and
the computer directing a change of ownership of the entity from stockholders to a first non-profit institution.

16. The method of claim 15, further comprising the computer verifying that the portfolio is held and managed by a second entity separate from the for-profit entity.

17. The method of claim 15, wherein profits from the portfolio are a primary source of revenue for the for-profit entity.

18. The method of claim 15, wherein non-financial goals of the stakeholders are charitable and align with goals of the first non-profit institution.

19. The method of claim 15, further comprising the computer advising the first non-profit and the for-profit entity to consummate the change of ownership on a non-cash basis.

20. The method of claim 15, further comprising the computer auditing distributions of the first non-profit institution to verify continued alignment with non-financial goals of the stakeholders.
